(19) United States
(12) Patent Application Publication
(10) Pub. No.: US 2004/0138896 A1
(43) Pub. Date: Jul. 15, 2004

(54) WEB BASED PROPERTY MANAGEMENT METHOD AND SYSTEM

(76) Inventor: TE CHAO CHENG, ITHACA, NY (US)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,371

(22) Filed: Jan. 15, 2003

(51) Int. Cl. G06F 17/60

(52) U.S. Cl. 705/1

(57) ABSTRACT

The present invention relates to a web based property management method and system. The web based property management method stores data inputting from the user into a database to be one of a plurality of records and the user can access the database to obtain data relating to the user and/or performing his/her predetermined functions, wherein, the web based property management method is implemented on a web services-based platform. Moreover, in one preferred embodiment of the present invention, the user comprising general user, tenant, landlord, and agent company.

### BACKGROUND OF INVENTION

1. Field of Invention

The present invention relates to a property management method and system. More particularly, the present invention relates to a web based property management method and web based system using the method.

2. Description of Related Art

Traditionally, a tenant, landlord and associated agent company in the property management market have to post up advertisements on the street to look for what they need. It is therefore difficult for them to effectively gather information about property.

In order to solve the problem, homepages which contain the information about properties are provided on the Internet. These homepages do make benefits to the tenants, the associated agent companies, and the landlords. However, as the homepages can make some benefits to ease efforts for gathering information, they are simply illustration figures or texts that provide information only, i.e. these homepages only provide information and do not provide any other functions.

In another aspect of the prior art, some agent companies utilize some applications to deal with database of their users, including the tenants and landlords. These applications have to be installed on a computer system in order to function well. Therefore, there are some drawbacks in these applications. One drawback is that these applications need to be installed before being used, and therefore users can not use these applications anywhere anytime. The second drawback is that the applications can not provide an interface between the users (general public, tenant and landlord) and the property management companies since the database is created and maintained by the agent companies only.

Therefore, there is need for a system that provides an interface between the users, including general users, tenants, landlords, and the agent companies, or so called property management companies. Furthermore, the system is preferred to be one that can manage property management oriented activities such as, the rent, the maintenance, the housekeeping, the tenant, the reporting, the property & person/company and etc. software services instead of doing these works by hands or by stand alone PC/workstations.

### SUMMARY OF INVENTION

Accordingly, the invention provides a property management method and system to form an interface between the general public, the tenants, landlords, and/or the agent companies.

Moreover, the invention provides a property management method and system to manage the property management oriented activities in a real time on demand basis to optimize property management operations dynamically respond to the needs of the landlord, tenants, agent company and general public.

As embodied and broadly described herein, the present invention provides a web based property management method, which is adapted to a property management system for a user. The web based property management method stores a message inputting from the user into a database to be one of a plurality of records and the user can access the database to obtain data relating to the user, wherein, the web based property management method is implemented on a web services-based platform. Moreover, in one preferred embodiment of the present invention, the user comprising general user, tenant, landlord, and agent company.

In one embodiment of the present invention, a plurality of interfaces are provided to provide the functions for illustrating a rent status, a maintenance, a housekeeping, a tenant status, a reporting data and processing functions and a property & person/company processing functions to the users.

In a preferred embodiment, a first interface that contains the rent status and processing functions to the user provides a plurality of items which is followed by an associated item data, and amends the item data while the user choose the associated item, wherein, the items including a notify rent letter, a rent due letter, a late fee calculation, a deposit check, a NSF check, a reconciling bank statement and an account processing module. Moreover, the items in a second interface that contains the maintenance and processing functions to the user comprise a maintenance request, a maintenance payment, a work assignment and an account processing module, and the items in a third interface that contains the housekeeping and processing functions to the user comprise a reminder, an inventory, a handyman/contractor list, an inspection list, a mortgage payment, an insurance payment, a my parking lot, a my lease and a utility list. Furthermore, the items in a fourth interface that contains the tenant status and processing functions to the user comprise a check in/out status, a rent & fee & damage check, a tenant file query & update, an account processing module, a credit check and a security deposit, the items in a fifth interface that contains the reporting data and processing functions to the user comprise a monthly account table, an year end closing table, my money and a plurality tax reports, and the items in a sixth interface that contains my property, my contact and my folder.

Furthermore, the present invention provides a web based property management method, which is adapted to a property management system for a user. The web based property management method accepts a request from the user, determines whether the user has been registered and, if the user has been registered, determines whether the user is tenant or general public. Thereafter, when the user is tenant or general public, the user is given rights that can change, add and check his messages, and the old messages are stored as history.

In a preferred embodiment of the present invention, the property management method further comprises the step that when the user is not tenant or general pubic, giving the user rights that at least can change, add and check his own messages and or assigned tasks (employee of the agent company), check and response all messages sent to the user, and the old messages are stored as history, and perform other predetermined processes.

In other preferred embodiment of the present invention, the property management method further comprises the step that asking the user to register and only shows the user basic data that can not be amended if the user does not register.

In another preferred embodiment, the property management method accepts the request via a web browser.

Furthermore, the present invention provides a web based property management system, which comprises a web services-based interface, storage and a processing unit. The web services-based interface is used for inputting data from a user; the storage stores a long-term data and a short-term data; and the processing unit performs a plurality of processes to make communication between the users, and to access data in the storage.

In a preferred embodiment, the processing unit of the property management system further provides a board for collecting all messages for respective user. Moreover, the processing unit deletes the short-term data from the storage when any one of the users relating to the short-term data is deleted from the storage.

In the invention, data are input via a web services-based interface and database that stores messages for communication between each user is provided. Hence, users need not install specified application before using the invention, and an efficient communication between tenant, landlord and agent company can be built. In the invention, an upload function will be able to help the users transmitted data and a down load functions will help users to perform certain functions in the user site. All functions will provide in an on demand environment that is automatic, build on open standards and integrated system.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a system block diagram of one preferred embodiment according to the present invention;

FIG. 1B is a system function block diagram of one preferred embodiment used for the system shown in FIG. 1A;

FIG. 2A is an interface block diagram illustrating part of the functions provided by one preferred embodiment according to the present invention;

FIG. 2B is an interface block diagram illustrating a continue part of the functions provided by one preferred embodiment according to the present invention; and

FIG. 3 is a flow chart illustrating the steps performed by another preferred embodiment according to the present invention.

### DETAILED DESCRIPTION

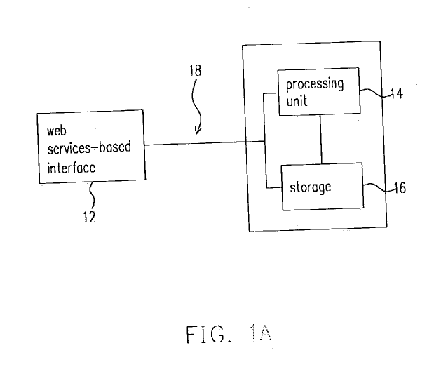

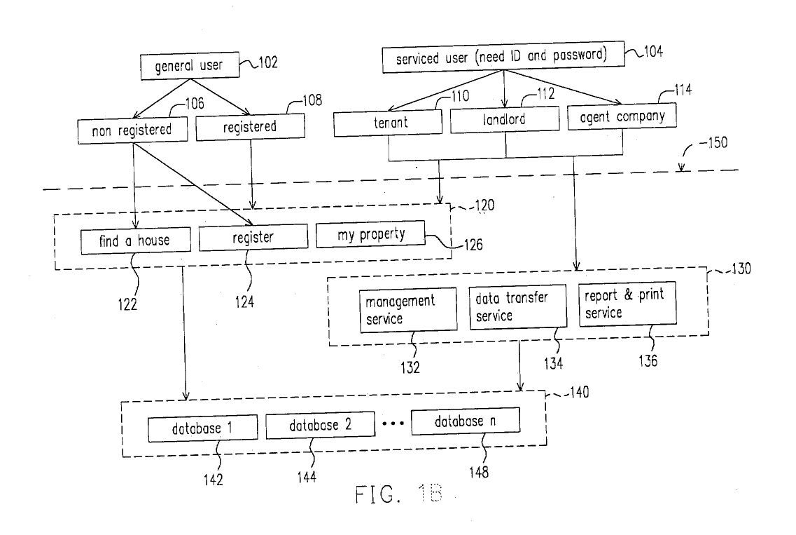

As illustrated in FIG. 1A, wherein a system block diagram of one preferred embodiment according to the present invention is shown, a property management system in the preferred embodiment comprises a web services-based interface 12, a processing unit 14 and a storage 16. The web services-based interface 12 is used for inputting data by users including general users, tenant, landlord/lessor and, even more, agent companies. The inputted data is transmitted via a transmission path 18, which can be Internet or Intranet, to the processing unit 14 and storage 16. After receiving the data from the web services-based interface 12, the processing unit 14 checks the validity of the data and performs associated processes according to the data. In the mean time, the storage 16 provides space for storing the inputted data or responses to requests from the processes performed by the processing unit 14. The web services-based property management system and method will be able to provide the users more services by linking other web services-based services and to provide the property management system to other services provider to link with their services. The Web-based property management system and method is a smart and reliable Web services networks, it will enhance the property management business process and integration, and provide an on demand services to optimize operation dynamically response to the need of the landlord, the tenant, agent company and general public as well.

Referring to FIG. 1B, wherein a system function block diagram of one preferred embodiment used in FIG. 1A is shown; a more detailed description of the present invention will be described by referring to this drawing and the drawings thereafter. As shown in FIG. 1B, the web based system includes a plurality of services, including on demand services 120 and core services 130, that can be performed by the processing unit 14 shown in FIG. 1A, a storage 140 that stores data for providing functions data requested by them, and a web based interface 150, which is a media for inputting requests by general user 102, including the non registered user 106 and the registered user 108, and serviced user 104, including tenant 110, landlord 112 and agent company 114.

The on demand services 120 includes a plurality of services such as find a house service 122, register service 124 and my property service 126. The find a house service 122 is the only function that can be accessed by a non registered user besides the register service 124, and the find a house service 122 functions to provide some information of for-rent service obtained from the storage 140. Moreover, the register service 124 serves as a tool for user registration, and my property service 126 is used to store any information chosen by the users into the storage 140 as short-term/long-term data.

Furthermore, the core services 130 includes a plurality of services such as management service 132, data transfer service 134 and report & print service 136. The management service 132 provides users several management functions to manage data stored in the storage 140. The data transfer service 134 transfers data via various method including upload and download a selected application module to user side so that user can run the application on his/her own computer. The report & print service 136 provides an application module downloaded to user side for report printing or to connect with EXCEL, WORD and etc. tools to view the data requested by the user, and moreover, provides also a web services-based service to connect printing service so that user can print reports anywhere in the STATES.

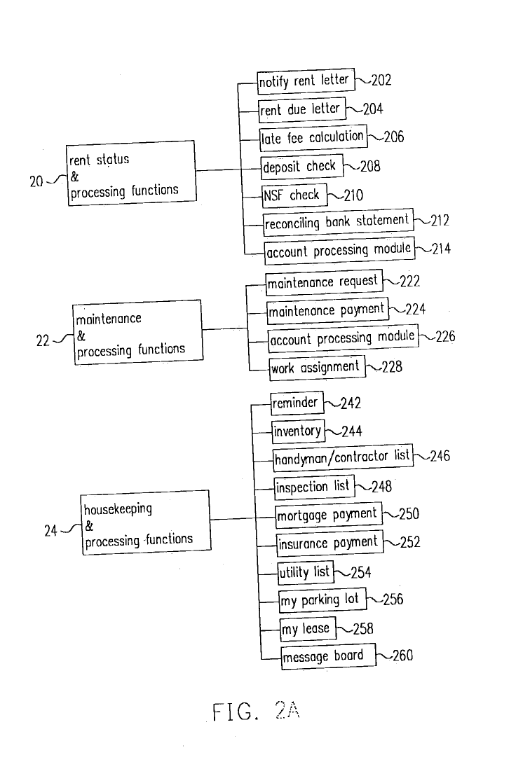

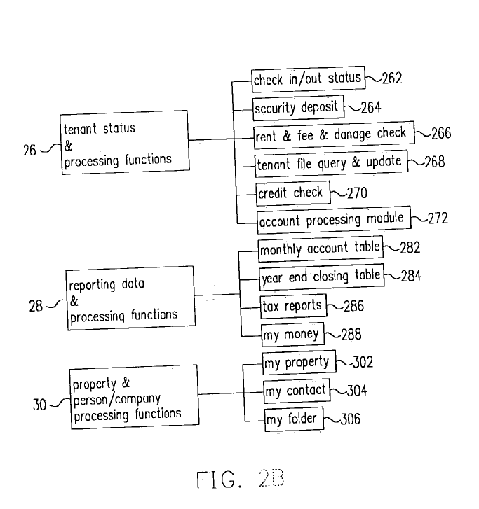

In one preferred embodiment according to the present invention, the interfaces 150 can be configured as the six interfaces 20 30 illustrated in FIGS. 2A and 2B. In the embodiment, the interfaces can be divided into six categories, including an interface rent status & processing functions 20 (hereinafter referred as rent status interface), an interface for maintenance & processing functions 22 (hereinafter referred as maintenance interface), an interface for housekeeping & processing functions 24 (hereinafter referred as housekeeping interface), an interface for tenant status & processing functions 26 (hereinafter referred as tenant status interface), an interface for reporting data & processing functions 28 (hereinafter referred as reporting interface), and an interface for property & person processing functions 30 (hereinafter referred as property interface).

The rent status interface 20 includes a plurality of items, which are relating to rent status and associated processing functions, such as notify rent letter 202, rent due letter 204, late fee calculation 206, deposit check 208, NSF check 210, reconciling bank statement 212 and account processing module 214. These items contain at least one associated item data, which either follows the corresponding item or appears after the corresponding item is pressed, respectively. Users can access these item data by choosing the item data such as simply clicking on the item or the item data.

The maintenance interface 22 includes a plurality of items, which are relating to maintenance and processing functions, such as maintenance request 222, maintenance payment 224, account processing module 226 and work assignment 228. These items contain at least one associated item data, which either follows the corresponding item or appears after the corresponding item is pressed, respectively. Users can access these item data by choosing the item data such as simply clicking on the item or the item data.

The housekeeping interface 24 includes a plurality of items, which are relating to housekeeping and processing functions, such as reminder 242, inventory of the house 244, handyman/contractor list 246, inspection list 248, mortgage payment 250, insurance payment 252, utility list 254, my parking lot 256, my lease 258, and message board 260. These items contain at least one associated item data, which either follows the corresponding item or appears after the corresponding item is pressed, respectively. Users can access these item data by choosing the item data such as simply clicking on the item or the item data.

The tenant status interface 26 includes a plurality of items, which are relating to tenant status and processing functions, such as tenant check in/out status 262, security deposit 264, rent, fee, and damage check 266, tenant file query and update 268, credit check 270 and account processing module 272. These items contain at least one associated item data, which either follows the corresponding item or appears after the corresponding item is pressed, respectively. Users can access these item data by choosing the item data such as simply clicking on the item or the item data.

The reporting interface 28 includes a plurality of items, which are relating to reporting data and processing functions, such as monthly account table 282, year end closing table 284, tax reports 286 and my money 288. These items contain at least one associated item data, which either follows the corresponding item or appears after the corresponding item is pressed, respectively. Users can access these item data by choosing the item data such as simply clicking on the item or the item data. Moreover, these item data are preferred to be obtained from the operation results of the interfaces 20-26 and 30 instead of being inputted by human beings.

The property interface 30 includes a plurality of items, which are relating to property, person and company processing functions such as my property 302, my contact 304, and my folder 306. These items contain at least one associated item data, which either follows the corresponding item or appears after the corresponding item is pressed, respectively. Users can access these item data by choosing the item data such as simply clicking on the item or the item data.

Referring back to FIG. 1B again, the storage 140 includes a plurality of database 142-148. In the preferred embodiment shown in the FIG. 1B, the database 142 is used to store short-term data, such as rental information for user's request. The database 144 stores long-term data and supplies the data to users via various interfaces. Moreover, a board is preferred to be provided for collecting all messages for respective user, and the short-term data is deleted from the storage 140 when the user relating to the short-term data is deleted from the storage 140.

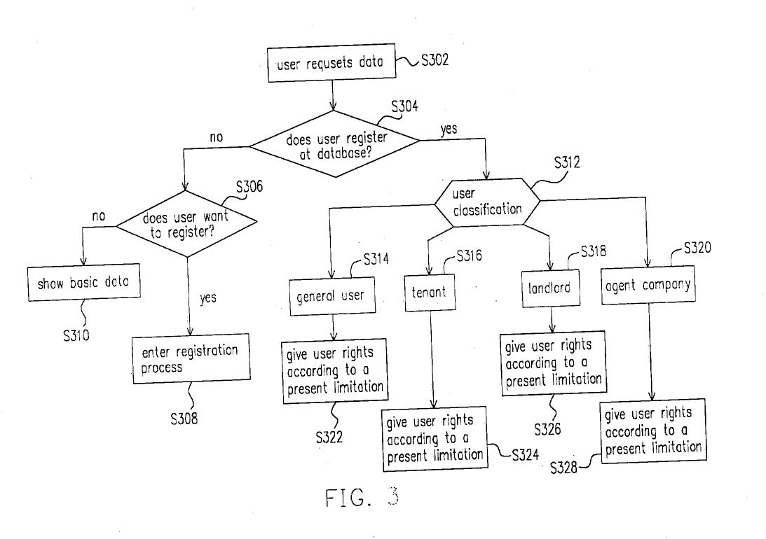

Referring to FIG. 3, a flow chart illustrating the steps performed by another preferred embodiment according to the present invention is shown. In the embodiment, user requests data in step S302, and a determining process that determines whether the user registers at database or not is performed in step S304. If the user has not registered at database, step S306 prompts the user to register, and, thereafter, the user is guided into a registration process in step S308 if the user wants to register, otherwise only basic data that is predetermined to show is displayed (step S310).

Furthermore, if the user is determined to be a registered one in step S304, classification of the user is then be determined in step S312. When the user is determined to be a general user, the method goes to step S314 and gives the general user rights according to a preset limitation. Similarly, if the user is determined to be a tenant, landlord or agent company, the method will go to step S316, S318 or S320, respectively, and the rights given to the user may be different according to the limitations in step S324, S326 and S328. For example, the rights for a tenant in the embodiment are to access his own data, such as changing, adding and checking his own messages and letters. Moreover, the old messages or letters do not be erased from the database but saved in the database to be a history, that is, a record, such as a message or a letter, that is going to be amended is still stored in the database to form a history of the record, and the amended record is stored into the database to be a newest record of the record.

Moreover, when the user is determined to be a landlord or an agent company in the embodiment, the user can manage all records, including messages or letters to the user from the tenant, any landlord/lessor or any agent companies, or any posts to the user in a bulletin board. Furthermore, other processes provided by the realty management system, such as showing all records relating to him, making tax report, arranging maintenance and etc., can be performed as well if the access rights are agreed to the users. Therefore, the method provides users to communicate with each other, including registered general user to other users, tenant to other users, landlord to other users and agent company to other users.

In conclusion, the present invention has the following advantages: data are input via a web-browser based interface. Hence, users need not install specified application before using the invention, and an efficient communication between tenant, landlord and agent company can be built and provide the landlord and agent company an effective real-time system to run their daily activities. Users need not install any application, no need for technical professional to build network, maintaining hardware and software. Moreover, the web services-based interface also gives the advantages that will be able to integrate other useful Web services-based service to the invention system for the best benefit of the users.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A web based property management method, which is adapted to a property management system for a user, comprising:
storing a message inputting from the user into a database to be one of a plurality of records; and
the user can access the database to obtain data relating to the user;
wherein, the web based property management method is implemented on a web services-based platform.

2. The web based property management method of claim 1, wherein the user comprising general user, tenant, landlord, and agent company.

3. The web based property management method of claim 1, further comprising:
providing the user a first interface that contains a rent status and processing functions, which is used to input and manages rent;
providing the user a second interface that contains a maintenance and processing functions, which is used to input and manage maintenance matters;
providing the user a third interface that contains a housekeeping and processing functions which is used to handle housekeeping matters;
providing the user a fourth interface that contains a tenant status and processing functions, which is used to manage and query tenant database;
providing the user a fifth interface that contains a reporting data and processing functions; and
providing the user a sixth interface that contains a property & person/company processing functions, which input and maintenance property, person and company data.

4. A web based property management method, which is adapted to a property management system for a user, comprising:
accepting a request from the user;
determining whether the user registers;
determining whether the user is tenant if the user registers; and
when the user is tenant, giving the user rights that can access his own messages and stores old messages as history.

5. The web based property management method of claim 4, further comprising the step that when the user is not tenant, giving the user rights that at least can access his own messages, check and response all messages sent to the user, and perform other predetermined processes.

6. The web based property management method of claim 4, further comprising the step that asking the user to register if the user does not register when the user does not register.

7. The web based property management method of claim 6, further comprising the step that showing the user basic data.

8. The web based property management method of claim 4, wherein the accepted request is input via a web browser.

9. The web based property management method of claim 4 is implemented on a web services-based platform.

10. The web based property management method of claim 4, further comprising:
providing the user a first interface that contains a rent status and processing functions, which is used to input and manages rent;
providing the user a second interface that contains a maintenance and processing functions, which is used to input and manage maintenance matters;
providing the user a third interface that contains a housekeeping and processing functions which is used to handle housekeeping matters;
providing the user a fourth interface that contains a tenant status and processing functions, which is used to manage and query tenant database;
providing the user a fifth interface that contains a reporting data and processing functions; and
providing the user a sixth interface that contains a property & person/company processing functions, which input and maintenance property, person and company data.

11. The web based property management method of claim 10, wherein the step which provides the first interface that contains the rent status and processing functions to the user comprising:
providing a plurality of items which is followed by an associated item data; and
accessing the item data while the user choose the associated item;
wherein, the items including at least one of a notify rent letter, a rent due letter, a late fee calculation, a deposit check, a NSF check, a reconciling bank statement and an account processing module.

12. The web based property management method of claim 10, wherein the step which provides the second interface that contains the maintenance and processing functions to the user comprising:
providing a plurality of items which is followed by an associated item data; and
accessing the item data while the user choose the associated item;
wherein, the items including at least one of a maintenance request, a work assignment, a maintenance payment and an account processing module.

13. The web based property management method of claim 10, wherein the step which provides the third interface that contains the housekeeping and processing functions to the user comprising:
providing a plurality of items which is followed by an associated item data; and
accessing the item data while the user choose the associated item;
wherein, the items including at least one of a reminder, an inventory, a handyman/contractor list, an inspection list, a mortgage payment, an insurance payment, my parking lot, my lease, a utility list and a message board.

14. The web based property management method of claim 10, wherein the step which provides the fourth interface that contains the tenant status and processing functions to the user comprising:
providing a plurality of items which is followed by an associated item data; and
accessing the item data while the user choose the associated item;
wherein, the items including at least one of a check in/out status, a security deposit, a rent, fee, damage check, a tenant file query and update and a credit check.

15. The web based property management method of claim 10, wherein the step which provides the fifth interface that contains the reporting data and processing functions to the user comprising:
providing a plurality of items which is followed by an associated item data; and
accessing the item data while the user choose the associated item;
wherein, the items including at least one of a monthly account table/statement, an year end closing table/statement, a plurality tax reports and my money.

16. The web based property management method of claim 10, wherein the step which provides the six interface that contains the reporting data and processing functions to the user comprising:
providing a plurality of items which is followed by an associated item data; and
accessing the item data while the user choose the associated item;
wherein, the items including at least one of my property, my contact, and my folder.

17. A web based property management system, comprising:
a web-services based interface, which is used for inputting data from a user;
a storage, which stores a long-term data and a short-term data; and
a processing unit, which performs a plurality of processes to make communication between the users, and to access data in the storage.

18. The web based property management system of claim 17, wherein the processing unit further providing a board for collecting/broadcasting all messages for respective user.

19. The web based property management system of claim 17, wherein the processing unit deletes the short-term data from the storage when any one of the users relating to the short-term data is deleted from the storage.
